(19) United States
(12) Patent Application Publication
(10) Pub. No.: US 2023/0190569 A1
(43) Pub. Date: Jun. 22, 2023

(54) ROTATING SOFT TISSUE MOBILIZATION DEVICE

(71) Applicant: Jesse Wallace, San Antonio, TX (US)

(72) Inventor: Jesse Wallace, San Antonio, TX (US)

(21) Appl. No.: 17/554,988

(22) Filed: Dec. 17, 2021

(51) Int. Cl. A61H 7/00

(52) U.S. Cl. CPC A61H 7/001; A61H 2201/1253; A61H 2201/0192; A61H 2201/1685

(57) ABSTRACT

The rotating soft tissue mobilization device disclosed herein may comprise support mechanism and a compression mechanism connected by a round slide bar to allow for complete relative rotation between the two mechanisms. The advantage of having a round slide bar allows the rotating soft tissue mobilization device to be applied to areas of the body not accessible by devices known in the art. The rotating soft tissue mobilization device may further comprise a plurality of interchangeable pressure applicators and support pads to further increase its functionality.

### TECHNICAL FIELD OF THE INVENTION

The present invention relates in general to massage devices, and, more specifically, to a rotating soft tissue mobilization device.

### COPYRIGHT AND TRADEMARK NOTICE

A portion of the disclosure of this patent application may contain material that is subject to copyright protection. The owner has no objection to the facsimile reproduction by anyone of the patent document or the patent disclosure, as it appears in the Patent and Trademark Office patent file or records, but otherwise reserves all copyrights whatsoever.

Certain marks referenced herein may be common law or registered trademarks of third parties affiliated or unaffiliated with the applicant or the assignee. Use of these marks is by way of example and should not be construed as descriptive or to limit the scope of this invention to material associated only with such marks.

### BACKGROUND OF THE INVENTION

Instrument-assisted soft tissue mobilization (IASTM) is a manual therapy technique that is commonly used to treat dysfunctions in ligaments and other musculoskeletal tissues based on the principles of cross-friction massage. A plurality of devices are implemented to apply compression to various parts of the body, and these devices are often contoured to appropriately apply force in different areas. The purpose of the devices is to break down fascial restrictions, adhesions, and scar tissue that may be causing pressure or limitations within the musculature.

One embodiment of such devices may comprise a rounded or beveled bar, which may be straight or curved, that may be used to apply direct pressure to soft tissue musculature by pressing or rolling against the body. Another embodiment of such devices may comprise a plate or other flat instrument, which may comprise curves in its edge, that may be used to apply such pressure. The problem with such devices is that they can only be used by the user to apply pressure to areas of their body within reach. For these devices to apply pressure to the back or other areas that are difficult to access the devices must be applied by a second user.

Another embodiment of such devices is disclosed in patent application 2019/0142685 to Heller, which shows a device that comprises a support component and a compression component connected via a slide bar. The support component can be placed against a first part of the body while the compression component may be compressed against a second part of the body. The advantage of such a device is that a user can apply pressure from the device to areas that are difficult to access without the assistance of a second user. The problem with such a device, though, is that it uses a rectangular slide bar that prevents relative rotation of the two components of the device. This prevention of rotation necessarily limits the areas of the body to which the device may be applied, and the mechanism of compression that may be applied.

Thus, there is a need in the art for a rotating soft tissue mobilization device that may comprise support mechanism and a compression mechanism connected by a round slide bar to allow for complete relative rotation between the two mechanisms. The advantage of having a round slide bar allows the rotating soft tissue mobilization device to be applied to areas of the body not accessible by devices known in the art. The rotating soft tissue mobilization device may further comprise a plurality of interchangeable pressure applicators and support pads to further increase its functionality. It is to these ends that the present invention has been developed.

### BRIEF SUMMARY OF THE INVENTION

To minimize the limitations in the prior art, and to minimize other limitations that will be apparent upon reading and understanding the present specification, the present invention describes a rotating soft tissue mobilization device.

It is an objective of the present invention to provide a rotating soft tissue mobilization device that may comprise a support mechanism.

It is another objective of the present invention to provide a rotating soft tissue mobilization device that may comprise a compression mechanism.

It is another objective of the present invention to provide a rotating soft tissue mobilization device that may comprise a squeeze handle.

It is another objective of the present invention to provide a rotating soft tissue mobilization device that may comprise a round slide bar.

It is another objective of the present invention to provide a rotating soft tissue mobilization device that may comprise a plurality of interchangeable pressure applicators.

It is another objective of the present invention to provide a rotating soft tissue mobilization device that may comprise a plurality of interchangeable support pads.

It is another objective of the present invention to provide a rotating soft tissue mobilization device that may comprise a resilient material of construction.

It is another objective of the present invention to provide a rotating soft tissue mobilization device that may comprise a water-proof material of construction.

It is another objective of the present invention to provide a rotating soft tissue mobilization device that may comprise a reusable material of construction.

It is another objective of the present invention to provide a rotating soft tissue mobilization device that may comprise an antimicrobial layer.

It is another objective of the present invention to provide a rotating soft tissue mobilization device that may comprise an antimicrobial material of construction.

These and other advantages and features of the present invention are described herein with specificity so as to make the present invention understandable to one of ordinary skill in the art, both with respect to how to practice the present invention and how to make the present invention.

### BRIEF DESCRIPTION OF THE SEVERAL VIEWS OF THE DRAWINGS

Elements in the figures have not necessarily been drawn to scale in order to enhance their clarity and improve understanding of these various elements and embodiments of the invention. Furthermore, elements that are known to be common and well understood to those in the industry are not depicted in order to provide a clear view of the various embodiments of the invention.

FIG. 1 is an isometric perspective view of a rotating soft tissue mobilization device, as contemplated by the present disclosure;

FIG. 2 is a front plan view of a rotating soft tissue mobilization device, as contemplated by the present disclosure;

FIG. 3 is a rear plan view of a rotating soft tissue mobilization device, as contemplated by the present disclosure;

FIG. 4 is a left side elevation view of a rotating soft tissue mobilization device, as contemplated by the present disclosure;

FIG. 5 is a right side elevation view of a rotating soft tissue mobilization device, as contemplated by the present disclosure;

FIG. 6 is a top plan view of a rotating soft tissue mobilization device, as contemplated by the present disclosure;

FIG. 7 is a bottom plan view of a rotating soft tissue mobilization device, as contemplated by the present disclosure;

FIG. 8 is an exploded component view of a rotating soft tissue mobilization device, as contemplated by the present disclosure;

FIG. 9 is a front plan view of a rotating soft tissue mobilization device showing the relative rotation of the support mechanism and the compression mechanism, as contemplated by the present disclosure;

FIG. 10 is hemisection view of a rotating soft tissue mobilization device, as contemplated by the present disclosure; and

FIG. 11 is a detailed hemisection view of the compression mechanism of a rotating soft tissue mobilization device, as contemplated by the present disclosure.

### DETAILED DESCRIPTION OF THE INVENTION

Certain terminology is used in the following description for reference only and is not limiting. The words “front,” “rear,” “anterior,” “posterior,” “lateral,” “medial,” “upper,” “lower,” “outer,” “inner,” and “interior” refer to directions toward and away from, respectively, the geometric center of the invention, and designated parts thereof, in accordance with the present disclosure. Unless specifically set forth herein, the terms “a,” “an,” and “the” are not limited to one element, but instead should be read as meaning “at least one.” The terminology includes the words noted above, derivatives thereof, and words of similar import.

The rotating soft tissue mobilization device disclosed herein may comprise support mechanism and a compression mechanism connected by a round slide bar to allow for complete relative rotation between the two mechanisms. The advantage of having a round slide bar allows the rotating soft tissue mobilization device to be applied to areas of the body not accessible by devices known in the art. The rotating soft tissue mobilization device may further comprise a plurality of interchangeable pressure applicators and support pads to further increase its functionality.

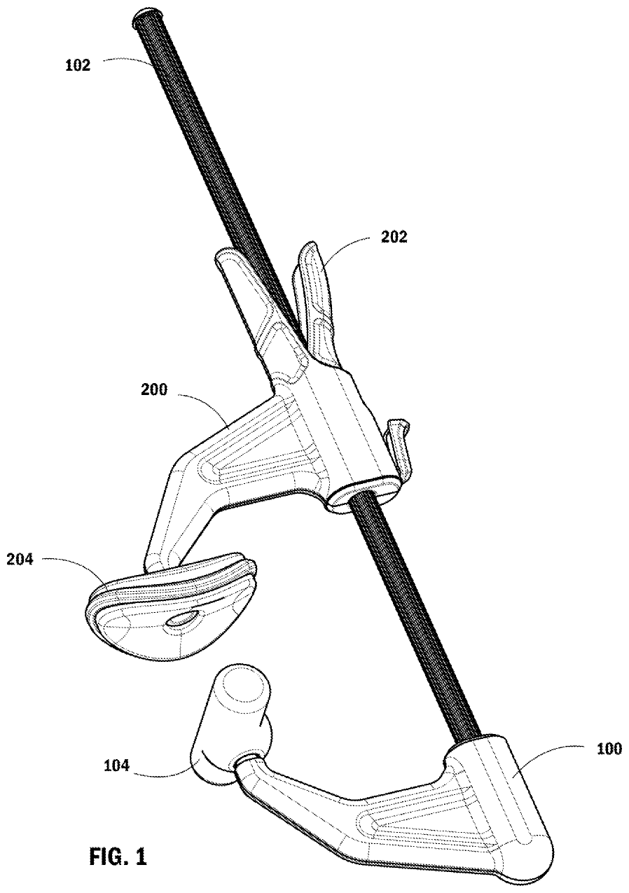

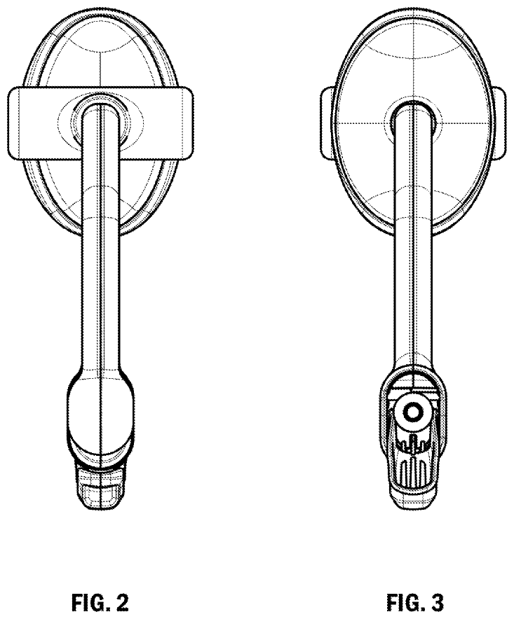

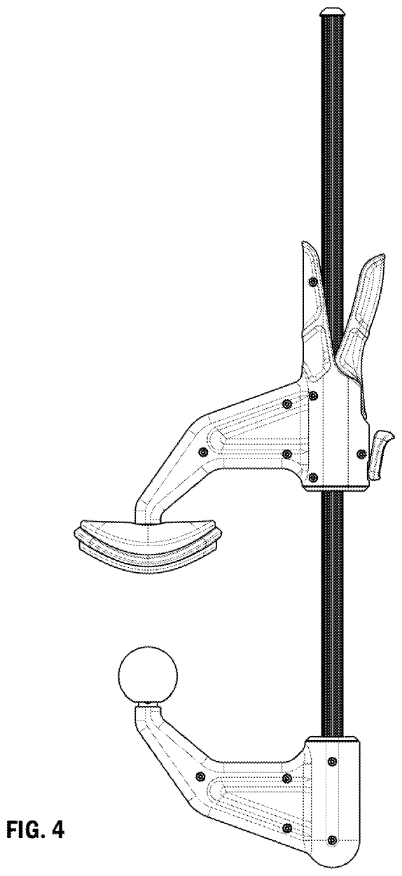

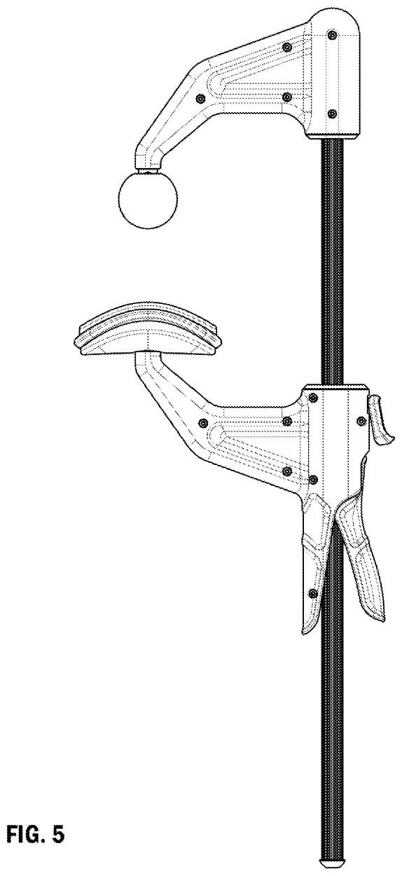

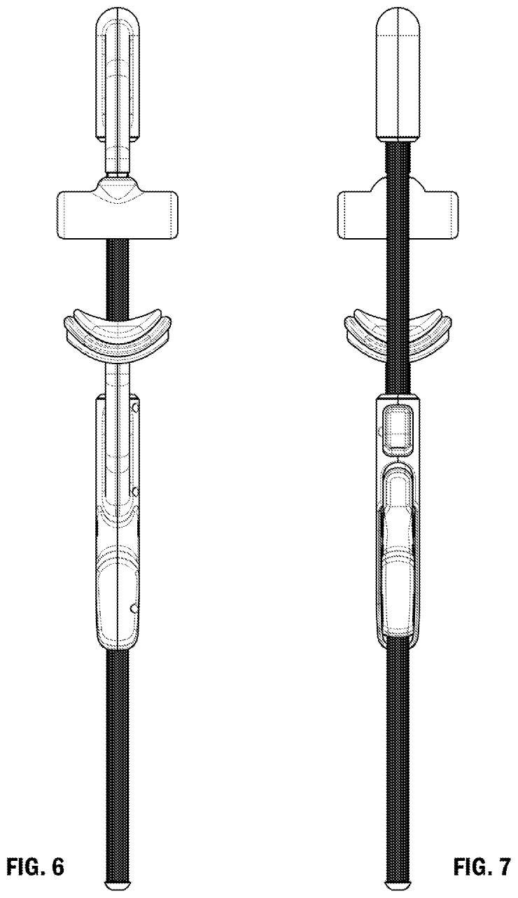

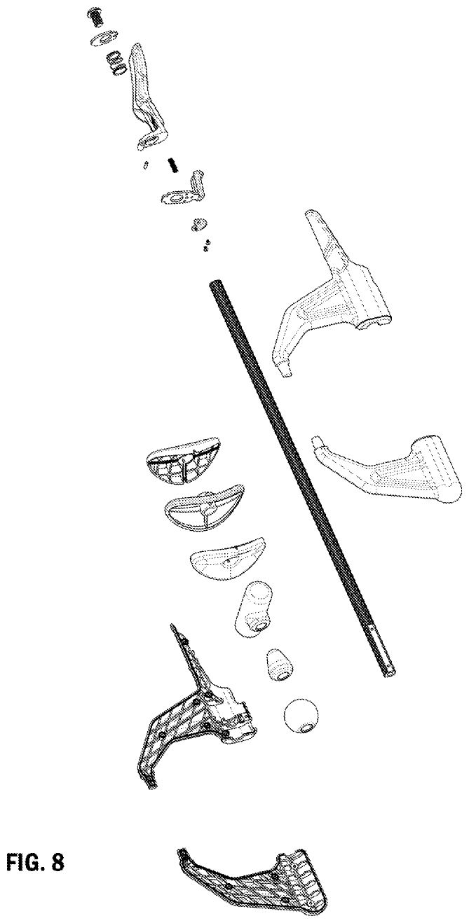

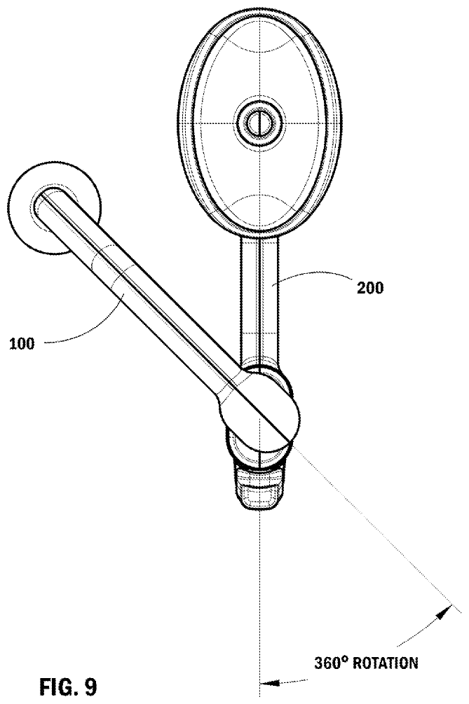

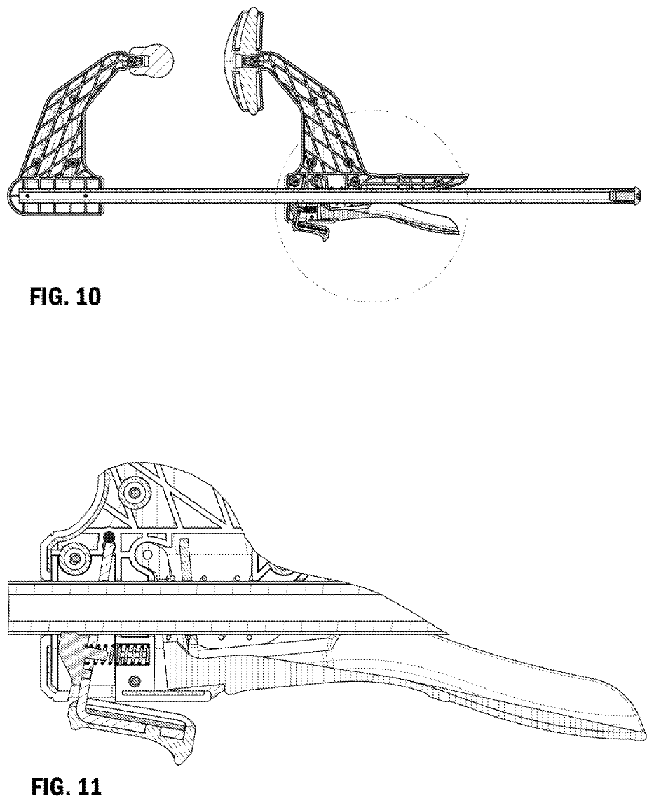

The illustrations of FIGS. 1-11 illustrate a rotating soft tissue mobilization device, as contemplated by the present disclosure. The rotating soft tissue mobilization device may comprise, generally, a compression mechanism 100 fixedly attached to a round slide bar 102. The support mechanism 200 may be reversibly attached to the round slide bar 102 by a squeeze handle 202. The compression mechanism 100 may further comprise a provision to receive one of a plurality of interchangeable pressure applicators 104, and the support mechanism 200 may further comprise a provision to receive one of a plurality of interchangeable support pads 204.

The compression mechanism 100 may comprise a solid component of any appropriate shape for allowing pressure to be applied to a part of the body. By way of example, the compression mechanism 100 may comprise a substantially triangulated shape for structural rigidity and to allow attachment to the round slide bar 102. The compression mechanism 100 may further comprise an attachment point for one of the interchangeable pressure applications 104, and may comprise an undercut so as to allow space for a body within the device.

The round slide bar 102 may comprise a solid bar having a circular cross-section that may be fixedly attached to the compression mechanism 100. The round slide bar 102 may provide a structural connection between the compression mechanism 100 and the support mechanism 200. The circular cross-section of the round slide bar 102 is crucial to the present device as it allows for three hundred and sixty degrees of relative rotation between the compression mechanism 100 and the support mechanism 200 axially around the round slide bar 102.

The interchangeable pressure applicators 104 may comprise any shape appropriate for applying pressure to a body. By way of example, one each of the interchangeable pressure applicators 104 may comprise a ball shape, a cylindrical shape, a triangulated shape, or any other appropriate shape.

The support mechanism 200 may comprise a solid component of any appropriate shape for allowing pressure to be applied to a part of the body. By way of example, the support mechanism 200 may comprise a substantially triangulated shape for structural rigidity and to allow attachment to the round slide bar 102. The support mechanism 200 may further comprise an attachment point for one of the interchangeable support pads 204, and may comprise an undercut so as to allow space for a body within the device.

The squeeze handle 202 may comprise a handle integrated into the support mechanism 200 and which engages the round slide bar 102. The squeeze handle 202 may reversibly attach to the round slide bar 102 by a spring action when the handle is released, and may disengage from the round slide bar 102 when the handled is compressed. When the squeeze handle 202 is released the support mechanism 200 may be tightly attached to the round slide bar 102, and when the squeeze handle 202 is compressed the support mechanism 200 may be allowed to move freely along and rotate freely around the round slide bar 102.

The squeeze handle 202 may further comprise a mechanism that incrementally advances the support mechanism 200 along the round slide bar 102 towards the compression mechanism 100 when the squeeze handle 202 is compressed so as to allow the device to be tightened on a body.

The interchangeable support pads 204 may comprise any pad appropriate for applying pressure to a body. By way of example, one each of the interchangeable support pads 204 may comprise a circular pad, a concave pad, a convex pad, or any other appropriate pad.

To begin using the device a user may first place the selected interchangeable support pad 204 attached to the support mechanism 200 against a part of their body opposite the area to be treated. They may then engage the squeeze handle 202 to allow free movement of the compression mechanism 100 around the round slide bar 102 and may place the selected interchangeable pressure applicator 104 attached to the compression mechanism 100 against a part of their body to be treated. The user may then repeatedly engage the squeeze handle 202 to advance the support mechanism 200 along the round slide bar 102 towards the compression mechanism 100 to tighten the device on the body.

The rotating soft tissue mobilization device may be substantially constructed of any suitable material or combination of materials, but typically is constructed of a resilient material or combination of materials such that the device is easily manufactured, insulating, and reusable. As an example, and without limiting the scope of the present invention, various exemplary embodiments of the rotating soft tissue mobilization device may be substantially constructed of one or more materials of plastic, acrylic, polycarbonate, fabric, steel, aluminum, brass, fiberglass, carbon fiber, or combinations thereof. In some embodiments the various components of the device may be coated, lined, or otherwise insulated to prevent contamination of the device.

In one embodiment the rotating soft tissue mobilization device may comprise a resilient material of construction that either comprises a material having antimicrobial properties or comprises a layering of antimicrobial material or coating. Antimicrobial properties comprise the characteristic of being antibacterial, biocidal, microbicidal, anti-fungal, anti-viral, or other similar characteristics, and the oligodynamic effect, which is possessed by copper, brass, silver, gold, and several other metals and alloys, is one such characteristic. Copper and its alloys, in particular, have exceptional self-sanitizing effects. Silver also has this effect, and is less toxic to users than copper. Some materials, such as silver in its metallic form, may require the presence of moisture to activate the antimicrobial properties.

While the invention has been described in connection with what is presently considered to be the most practical and preferred embodiments, it is to be understood that the invention is not to be limited to the disclosed embodiments, but, on the contrary, is intended to cover various modifications and equivalent arrangements included within the spirit and scope of the appended claims.

I claim:

1. A rotating soft tissue mobilization device, comprising:
a compression mechanism;
a round slide bar;
a support mechanism; and
a squeeze handle;
wherein said compression mechanism is fixedly attached to said round slide bar;
wherein said squeeze handle is attached to said support mechanism;
wherein said support mechanism is reversibly attached to said round slide bar by said squeeze handle; and
wherein engaging said squeeze handle allows said support mechanism to move freely along and around said round slide bar.

2. The rotating soft tissue mobilization device of claim 1, further comprising:
a plurality of interchangeable pressure applicators.

3. The rotating soft tissue mobilization device of claim 2, further comprising:
a plurality of interchangeable support pads.
